(19) United States
(12) Patent Application Publication
(10) Pub. No.: US 2020/0055766 A1
(43) Pub. Date: Feb. 20, 2020

(54) 3D LASER PERFORATION THERMAL SAGGING PROCESS

(71) Applicant: CORNING INCORPORATED, CORNING, NY (US)

(72) Inventors: Alejandro Antonio Becker, Stockdorf (DE); Michele Marie-Louise Fredholm, Vulaines sur Seine (FR); Thomas Hackert, Germering (DE); Albert Roth Nieber, Painted Post, NY (US); Sergio Tsuda, Horseheads, NY (US)

(21) Appl. No.: 16/608,037

(22) PCT Filed: Apr. 24, 2018
(86) PCT No.: PCT/US2018/029045

§ 371 Date: Oct. 24, 2019

Related U.S. Application Data
(60) Provisional application No. 62/489,705, filed on Apr. 25, 2017.

(51) Int. Cl. C03B 33/02; B23K 26/00; B23K 26/0622; B23K 26/359; B23K 26/53; C03B 23/025; C03B 33/033

(52) U.S. Cl. CPC C03B 33/0222; B23K 26/0006; B23K 26/0624; B23K 2103/54; B23K 26/53; C03B 23/0252; C03B 33/033; B23K 26/359

(57) ABSTRACT

In some embodiments, a method of forming a glass article comprises perforating a glass substrate along a contour with a laser forming a plurality of perforations, such that the contour separates a first portion of the glass substrate from a second portion of the glass substrate. After perforating, thermal forming the glass substrate into a non-planar shape with a mold, and separating the first portion of the glass substrate from the second portion of the glass substrate.

### CROSS-REFERENCE TO RELATED APPLICATIONS

This application claims the benefit of priority under 35 U.S.C. § 119 of U.S. Provisional Application Ser. No. 62/489,705 filed on Apr. 25, 2017, the content of which is relied upon and incorporated herein by reference in its entirety.

### BACKGROUND

### Field

The present disclosure relates to curved glass substrates with openings, articles including such glass substrates, and related processes.

### Background

Curved glass substrates are desirable in many contexts. One such context is for use as a cover glass for a curved display, which may be incorporated into an appliance, an architectural element (e.g., wall, window, modular furniture, shower door, mirrors etc.), a vehicle (e.g., automobiles, aircraft, sea craft and the like). Existing methods of forming such curved glass substrates, such as thermal forming, have drawbacks including optical distortion and surface marking. Automotive vehicles are looking for thin glass to cover interior consoles and dashboards. Processes to form these shapes are being developed along with cutting the needed holes for interior compartments (i.e. ash trays, coffee cup holders etc.). Extracting out the hole either round, square or rectangular is particularly challenging, especially at a low cost. Typically, cutting a hole in the glass requires diamond holes saws and grinding wheels with 3-5 axes motion. This disclosure offers a high speed method to cut and release the hole either during the 3D sagging process by means of a laser or by vacuum and other thermal approaches.

### BRIEF SUMMARY

In some embodiments, articles comprising an opening in the curved glass substrates are described, and methods of making such articles.

In some embodiments, a method of forming a glass article comprises perforating a glass substrate along a contour with a laser forming a plurality of perforations, such that the contour separates a first portion of the glass substrate from a second portion of the glass substrate. After perforating, the method according to one or more embodiments includes thermal forming the glass substrate into a non-planar shape with a mold, and separating the first portion of the glass substrate from the second portion of the glass substrate.

In some embodiments, the embodiments of any of the preceding paragraphs may further include the contour forming an opening in the glass article after the first portion is separated.

In some embodiments, the embodiments of any of the preceding paragraphs may further include, before separating, shrinking the first portion of the glass substrate relative to the second portion of the glass substrate by preferentially cooling the first portion.

In some embodiments, the embodiments of any of the preceding paragraphs may further include preferentially cooling the first portion comprising contacting the first portion with a cooling device.

In some embodiments, the embodiments of any of the preceding paragraphs may further include preferentially cooling the first portion comprising directing cool air at the first portion.

In some embodiments, the embodiments of any of the preceding paragraphs may further include separating comprising applying pressure during separating the first portion of the glass substrate from the second portion of the glass substrate.

In some embodiments, the embodiments of any of the preceding paragraphs may further include applying pressure, accomplished with a pressure application device, and the pressure application device preferentially cools the first portion.

In some embodiments, the embodiments of any of the preceding paragraphs may further include the pressure being applied by pulling.

In some embodiments, the embodiments of any of the preceding paragraphs may further include the pressure being applied by pushing.

In some embodiments, the embodiments of any of the preceding paragraphs may further include separating the first portion of the glass substrate from the second portion of the glass substrate comprising pulling the first portion of the glass substrate away from the mold.

In some embodiments, the embodiments of any of the preceding paragraphs may further include pulling the first portion of the glass substrate away from the mold being accomplished with a suction device.

In some embodiments, the embodiments of any of the preceding paragraphs may further include separating the first portion of the glass substrate from the second portion of the glass substrate comprising pulling the first portion of the glass substrate into a recess in the mold.

In some embodiments, the embodiments of any of the preceding paragraphs may further include separating the first portion of the glass substrate from the second portion of the glass substrate during thermal forming.

In some embodiments, the embodiments of any of the preceding paragraphs may further include separating the first portion of the glass substrate from the second portion of the glass substrate after thermal forming.

In some embodiments, the embodiments of any of the preceding paragraphs may further include a glass substrate that is flat during the perforating.

In some embodiments, the embodiments of any of the preceding paragraphs may further include thermal forming the glass substrate comprising thermal sagging the glass substrate into the mold by heating the glass substrate to a temperature at which the glass substrate sags under its own weight.

In some embodiments, the embodiments of any of the preceding paragraphs may further include disposing the glass substrate on a sacrificial glass substrate prior to thermal forming, thermal forming the glass substrate and the sacrificial glass substrate into the non-planar shape with the mold, separating the first portion of the glass substrate from the second portion of the glass substrate, and separating the glass substrate from the sacrificial glass substrate.

In some embodiments, the embodiments of any of the preceding paragraphs may further include spacing between two adjacent perforations from 1 um to 10 um.

In some embodiments, the embodiments of any of the preceding paragraphs may further include the shape of the first portion of the glass substrate selected from the group consisting of round, oval, rectangle, and triangle.

In some embodiments, the embodiments of any of the preceding paragraphs may further include the glass substrate having a thickness of 50 um to 2 mm.

In some embodiments, the embodiments of any of the preceding paragraphs may further include the depth of the perforations from 5% to 100% of the thickness of the glass substrate.

In some embodiments, the embodiments of any of the preceding paragraphs may further include a pico-second laser.

In some embodiments, the embodiments of any of the preceding paragraphs may further include an article formed by the method of forming a glass article comprising perforating a glass substrate along a contour with a laser forming a plurality of perforations, such that the contour separates a first portion of the glass substrate from a second portion of the glass substrate. After perforating, thermal forming the glass substrate into a non-planar shape with a mold, and separating the first portion of the glass substrate from the second portion of the glass substrate.

In some embodiments, the embodiments of any of the preceding paragraphs may further include a vehicle interior system comprising a base including a curved surface and the article described above disposed on the curved surface.

In some embodiments, the embodiments of any of the preceding paragraphs may further include a vehicle interior system wherein the contour forms an opening in the glass substrate after the first portion is separated, and the curved surface comprises any one of a button, knob and vent, that is accessible through the opening.

In some embodiments, the embodiments of any of the preceding paragraphs may further include the vehicle interior system wherein the base further comprises a display.

In some embodiments, the embodiments of any of the preceding paragraphs may further include the vehicle interior system wherein the display is visible through the opening.

In some embodiments, the embodiments of any of the preceding paragraphs may further include the vehicle interior system wherein the display is visible through the second portion.

In some embodiments, the embodiments of any of the preceding paragraphs may further include the vehicle interior system wherein the vehicle is any one of an automobile, a seacraft, and an aircraft.

### BRIEF DESCRIPTION OF THE DRAWINGS

The accompanying figures, which are incorporated herein, form part of the specification and illustrate embodiments of the present disclosure. Together with the description, the figures further serve to explain the principles of and to enable a person skilled in the relevant art(s) to make and use the disclosed embodiments. These figures are intended to be illustrative, not limiting. Although the disclosure is generally described in the context of these embodiments, it should be understood that it is not intended to limit the scope of the disclosure to these particular embodiments. In the drawings, like reference numbers indicate identical or functionally similar elements.

FIG. 1A shows a parent glass substrate.

FIG. 1B shows a parent glass substrate with a rectangular laser perforation pattern or contour.

FIG. 1C shows a parent glass substrate with a curved laser perforation pattern or contour.

FIG. 2A shows a curved glass article-parent glass substrate with an opening.

FIG. 2B shows the glass slug after separation from the parent glass substrate.

FIG. 3 shows a parent glass substrate with a laser perforation pattern and perforation dimensions (enlarged view).

FIG. 4 shows a top view of linked perforation cracks (highlighted) between adjacent perforations on a glass substrate.

FIGS. 5A-5C shows a cross-section view of the glass substrate with perforations of varying depths.

FIGS. 6A-6C illustrate circular perforations with varying pitch sizes.

FIG. 6D shows non-circular perforations forming a rectangular contour.

FIGS. 7A and 7B illustrate the thermal sagging and release method using a sacrificial glass substrate.

FIGS. 8A and 8B illustrate the thermal sagging and release method without a sacrificial glass substrate.

FIG. 9 shows a cross-section view of the recessed mold and the separated glass slug.

FIG. 10A illustrates a top view of the recessed mold.

FIG. 10B illustrates a cross-section view of the recessed mold along the plane 1-1′, with ejector pins to release the slug.

FIG. 11A illustrates a cross-section view of the recessed mold with a vacuum-assisted release of the slug.

FIG. 11B illustrates a cross-section view of the recessed mold with ejector pins to release the slug.

FIG. 12A illustrates a cross-section view of the mold with a cooled suction device contacting the slug.

FIG. 12B illustrates a cross-section view of the mold with a cooled suction device pulling the slug away from the mold.

FIG. 12C illustrates a cross-section view of the mold with a cooling device to preferentially cool the slug.

FIG. 13 shows a process flowchart for a laser perforating and thermal sagging process for 3D glass articles with an opening.

FIG. 14 shows a perspective view illustration of a vehicle interior with vehicle interior systems according to one or more embodiments.

### DETAILED DESCRIPTION

The next wave of consumer electronics products is incorporating not only software and hardware innovations, but also changes that have design and functional appeal. New products are being announced and released on a regular basis with some form of three dimensional (3D) glass part incorporated in them. Some examples include curved LCD TV screens, curved smart-phones and wearable gadgets (wrist phones, watches, etc.) that are either flexible or have a curved shape. Other elements of design in these types of devices are the back covers that have gone from the traditional flat glass cover plates to three dimensional curved surfaces of different styles. Automotive interiors have also adopted the trend of curved or 3D shaped glass surfaces. These innovations and trends bring new challenges to the manufacturing processes of these 3D parts that are made of glass, which invariably need to be scratch- and impact-resistant.

The difficulty to form the different shapes has increased significantly as most of production lines were designed to handle flat two-dimensional parts.

Other changes that add to the complexity of transitioning from 2D to 3D processing come from the material perspective. In 3D parts, the curves, bends and turns become sources of mechanical stress accumulation, which can greatly impact processing the part after it is hot formed.

The present application describes a process for cutting and separating a variety of shapes of molded 3D thin transparent brittle substrates with particular interest in strengthened or non-strengthened glass. The method allows cutting and extracting the 3D part, also referred to as a “slug” herein, to its final size with no required post process finishing steps. The method can be applied to 3D parts that are strengthened (for example, chemically ion-exchanged, or thermally tempered) or non-strengthened (raw glass).

The process separates parts in a controllable fashion with negligible debris, minimum defects, and low subsurface damage to the edges that preserves part strength.

In some embodiments, the process provides precision cutting and separation of a variety of shapes of 3D thin transparent brittle substrates. In one or more embodiments, the substrates may include glass substrates. In one or more embodiments, the glass substrates may be an alkali aluminosilicate glass, which may optionally be strengthened (such as the glass available from Corning Incorporated under the trademark Corning® Gorilla® Glass). Embodiment methods allow cutting and extracting one or more 3D parts, or parts with a 3D surface, to their final size with no required post-process finishing steps.

In some embodiments, a laser is utilized and is well suited for materials that are transparent to the selected laser wavelength. Demonstrations of the method have been made using 0.55 mm thick sheets of glass, e.g., alkali aluminosilicate glass having a nominal composition including about 69 mol % SiO₂, about 10.3 mol % Al₂O₃, about 15 mol % Na₂O, about 5.4 mol % MgO and about 0.17 mol % SnO₂.

In the process, an ultra-short pulsed laser is used to create a vertical defect line in the glass substrate. A series of defect lines create a fault line that delineates the desired contour of the shape and establishes a path of least resistance for crack propagation and along which separation and detachment of the shape from its substrate matrix occurs. The laser separation method can be tuned and configured to enable manual separation, partial separation or total separation of the 3D shapes out of the parent glass substrate.

In the first step, the object to be processed (e.g., glass substrate) is irradiated with an ultra-short pulsed laser beam that has been condensed into a high aspect ratio line focus with high energy density that penetrates through the thickness of the glass substrate. Within this volume of high energy density, the material is modified via nonlinear effects. The nonlinear effects provide a mechanism of transferring energy from the laser beam to the glass substrate to enable formation of the defect line. It is important to note that without this high optical intensity nonlinear absorption is not triggered. Below the intensity threshold for nonlinear effects, the glass substrate is transparent to the laser radiation and remains in its original state. By scanning the laser over a desired line or path, a narrow fault line (a plurality of vertical defect lines a few microns wide) defines the perimeter or shape of the part to be separated from the glass substrate.

In some embodiments, the pulse duration can be in a range of 1 picoseconds to 100 picoseconds, such as greater than about 5 picoseconds and less than about 20 picoseconds, and the repetition rate can be in a range of between about 1 kHz and 4 MHz, such as in a range of between about 10 kHz and 650 kHz. In addition to a single pulse at the aforementioned repetition rates, the pulses can be produced in bursts of two pulses or more (such as 3 pulses, 4, pulses, 5 pulses, 10 pulses, 15 pulses, 20 pulses, or more) separated by a duration in a range of between about 1 nsec and about 50 nsec, for example, 10 nsec to 30 nsec, such as about 20 nsec, and the burst repetition frequency can be in a range of between about 1 kHz and about 200 kHz. The pulsed laser beam can have a wavelength selected such that the glass substrate is substantially transparent at this wavelength. The average laser power measured at the glass substrate can be greater than 40 μJoules per mm thickness of substrate, for example between 40 μJoules/1 nm thickness of substrate and 1000 μJoules/1 nm thickness of substrate, or between 100 and 650 μJoules/1 nm thickness of substrate.

The laser beam focal line can have a length in a range of between 0.1 mm to 10 mm, such as about 1 mm, about 2 mm, about 3 mm, about 4 mm, about 5 mm, about 6 mm, about 7 mm, about 8 mm, or about 9 mm, or a length in a range of between about 0.1 mm and about 1 mm, and an average spot diameter in a range of between about 0.1 micron and about 5 microns. The holes or defect lines each can have a diameter between 0.1 microns and 100 microns, for example, 0.25 to 5 microns.

Once the fault line with vertical defects is created, separation can occur via: 1) manual or mechanical stress on or around the fault line; the stress or pressure should create tension that pulls both sides of the fault line apart and breaks the areas that are still bonded together; 2) using a heat source, to create a stress zone around the fault line to put the vertical defect lines in tension and induce partial or total self-separation, and 3) using a cooling source to induce tensile stress by introducing a thermal gradient in the glass substrate. The stress causes separation of the 3D shape out of the parent glass substrate. In all the cases, separation also depends on process parameters such as laser scan speed, laser power, parameters of lenses, pulse width, repetition rate, etc.

Cutting of a transparent material with a laser in accordance with the present disclosure may also be referred to herein as drilling or laser drilling or laser processing. The processes permit parts to be separated in a controllable fashion with negligible debris, minimum defects, and low subsurface damage to the edges, preserving strength of the glass substrate or workpiece. The workpiece is the material or object subjected to the laser methods disclosed herein and may also be referred to herein as a parent glass substrate. One or more parts or articles can be separated from the parent glass substrate. The parts or articles can include, for example, a glass cover for a phone that has a curved surface or glass for use in an automotive interior (including as a cover for an automotive interior display or instrument panel).

The present laser methods are well suited for materials that are transparent or substantially transparent to the selected laser wavelength in the linear intensity regime. Within the context of the present disclosure, a material or article is substantially transparent to the laser wavelength when the absorption of the material at the laser wavelength is less than about 10% per mm of material depth, or less than about 5% per mm of material depth, or less than about 2% per mm of material depth, or less than about 1% per mm of material depth. The present laser methods can take advantage of transparency of the glass substrate material to the laser wavelength in the linear regime of power (low laser intensity (energy density)). Transparency in the linear intensity regime reduces or prevents damage to the surface of the substrate as well as subsurface damage away from the region of high intensity defined by the focused laser beam.

As used herein, subsurface damage refers to the maximum size (e.g. length, width, and diameter) of structural imperfections in the perimeter surface of the part separated from the substrate or material subjected to laser processing in accordance with the present disclosure. Since the structural imperfections extend from the perimeter surface, subsurface damage may also be regarded as the maximum depth from the perimeter surface in which damage from laser processing in accordance with the present disclosure occurs. The perimeter surface of the separated part may be referred to herein as the edge or the edge surface of the separated part. The structural imperfections may be cracks or voids and represent points of mechanical weakness that promote fracture or failure of the part separated from the substrate or material. By minimizing the size of subsurface damage, the present method improves the structural integrity and mechanical strength of separated parts.

In accordance with methods described below, in a single pass, a laser can be used to create highly controlled full or partial perforations through the material, with extremely little (<75 μm, often <50 μm) subsurface damage and debris generation. Sub-surface damage may be limited to the order of 100 μm in depth or less, or 75 μm in depth or less, or 60 μm in depth or less, or 50 μm in depth or less, and the cuts may produce only low debris. This is in contrast to the typical use of spot-focused laser to ablate material, where multiple passes are often necessary to completely perforate the glass thickness, large amounts of debris are formed from the ablation process, and more extensive sub-surface damage >100 μm and edge chipping occur.

Thus, with the present methods, it is possible to create microscopic i.e., (<2 μm and >100 nm in diameter, and in some embodiments <0.5 μm and >100 nm in diameter) elongated defect lines (also referred to herein as perforations, holes, or damage tracks) in transparent materials using one or more high energy pulses or one or more bursts of high energy pulses. The perforations represent regions of the substrate material modified by the laser. The laser-induced modifications disrupt the structure of the substrate material and constitute sites of mechanical weakness. Structural disruptions include compaction, melting, dislodging of material, rearrangements, and bond scission. The perforations extend into the interior of the substrate material and have a cross-sectional shape consistent with the cross-sectional shape of the laser (generally circular). The average diameter of the perforations may be in the range from 0.1 μm to 50 μm, or in the range from 1 μm to 20 μm, or in the range from 2 μm to 10 μm, or in the range from 0.1 μm to 5 μm. In some embodiments, the perforation is a “through hole”, which is a hole or an open channel that extends from the top to the bottom of the substrate material. In some embodiments, the perforation may not be a continuously open channel and may include sections of solid material dislodged from the substrate material by the laser. The dislodged material blocks or partially blocks the space defined by the perforation. One or more open channels (unblocked regions) may be dispersed between sections of dislodged material. The diameter of the open channels may be <1000 nm, or <500 nm, or <400 nm, or <300 nm or in the range from 10 nm to 750 nm, or in the range from 100 nm to 500 nm. The disrupted or modified area (e.g., compacted, melted, or otherwise changed) of the material surrounding the holes in the embodiments disclosed herein, preferably has diameter of <50 μm (e.g., <10 μm).

The individual perforations can be created at rates of several hundred kilohertz (several hundred thousand perforations per second, for example). Thus, with relative motion between the laser source and the material these perforations can be placed adjacent to one another with spatial separations varying from sub-micron to several or even tens of microns as desired. Distance between adjacent defect lines along the direction of the fault lines can, for example, be in range from 0.25 μm to 50 μm, or in the range from 0.50 μm to about 20 μm, or in the range from 0.50 μm to about 15 μm, or in the range from 0.50 μm to 10 μm, or in the range from 0.50 μm to 3.0 μm or in the range from 3.0 μm to 10 μm. The spatial separation is selected in order to facilitate cutting.

In addition to transparency of the substrate material in the linear intensity regime, selection of the laser source is further predicated on the ability to induce multi-photon absorption (MPA) in the transparent material. MPA is the simultaneous absorption of multiple photons of identical or different frequencies in order to excite a material from a lower energy state (usually the ground state) to a higher energy state (excited state). The excited state may be an excited electronic state or an ionized state. The energy difference between the higher and lower energy states of the material is equal to the sum of the energies of the two or more photons. MPA is a nonlinear process that is generally several orders of magnitude weaker than linear absorption. It differs from linear absorption in that the strength of MPA depends on the square or higher power of the light intensity, thus making it a nonlinear optical process. At ordinary light intensities, MPA is negligible. If the light intensity (energy density) is extremely high, such as in the region of focus of a laser source (particularly a pulsed laser source), MPA becomes appreciable and leads to measurable effects in the material within the region where the energy density of the light source is sufficiently high. Within the focal region, the energy density may be sufficiently high to result in ionization.

At the atomic level, the ionization of individual atoms has discrete energy requirements. Several elements commonly used in glass (e.g., Si, Na, K) have relatively low ionization energies (5 eV). Without the phenomenon of MPA, a wavelength of about 248 nm would be required to create linear ionization at 5 eV. With MPA, ionization or excitation between states separated in energy by 5 eV can be accomplished with wavelengths longer than 248 nm. For example, photons with a wavelength of 532 nm have an energy of 2.33 eV, so two photons with wavelength 532 nm can induce a transition between states separated in energy by 4.66 eV in two-photon absorption (TPA), for example. Thus, atoms and bonds can be selectively excited or ionized in the regions of a material where the energy density of the laser beam is sufficiently high to induce nonlinear TPA of a laser wavelength having half the required excitation energy, for example.

MPA can result in a local reconfiguration and separation of the excited atoms or bonds from adjacent atoms or bonds. The structural or molecular modification creates a structural defect (the defect line, damage line, or perforation referred to hereinabove) that mechanically weakens the material and renders it more susceptible to cracking or fracturing upon application of mechanical or thermal stress. By controlling the placement of perforations, a contour or path along which cracking occurs can be precisely defined and precise micromachining of the glass substrate can be accomplished. The contour defined by a series of perforations may be regarded as a fault line and corresponds to a region of structural weakness in the material. The fault line defines the preferred contour for separation of a part from the material and controls the shape of the separated part. In one embodiment, micromachining includes separation of a part from the glass substrate processed by the laser, where the part has a precisely defined shape or perimeter determined by a fault line defining a closed contour of perforations formed through MPA effects induced by the laser. As used herein, the term closed contour refers to a perforation path formed by the laser line, where the path intersects with itself at some location. An internal contour is a path formed where the resulting shape is entirely surrounded by an outer portion of the glass substrate.

In one or more embodiments, the laser is an ultra-short pulsed laser (pulse durations on the order of 100 picoseconds or shorter) and can be operated in pulse mode or burst mode. In pulse mode, a series of nominally identical single pulses is emitted from the laser and directed to the substrate. In pulse mode, the repetition rate of the laser is determined by the spacing in time between the pulses. In burst mode, bursts of pulses are emitted from the laser, where each burst includes two or more pulses (of equal or different amplitude). In burst mode, pulses within a burst are separated by a first time interval (which defines a pulse repetition rate for the burst) and the bursts are separated by a second time interval (which defines a burst repetition rate), where the second time interval is typically much longer than the first time interval. As used herein (whether in the context of pulse mode or burst mode), time interval refers to the time difference between corresponding parts of a pulse or burst (e.g. leading edge-to-leading edge, peak-to-peak, or trailing edge-to-trailing edge). Pulse and burst repetition rates are controlled by the design of the laser and can typically be adjusted, within limits, by adjusting operating conditions of the laser. Typical pulse and burst repetition rates are in the kHz to MHz range.

The laser pulse duration (in pulse mode or for pulses within a burst in burst mode) may be 10⁻¹⁰ s or less, or 10⁻¹¹ s or less, or 10⁻¹² s or less, or 10⁻¹³ s or less. In the exemplary embodiments described herein, the laser pulse duration is greater than 10⁻¹⁵ s.

One feature of embodiment processes is the high aspect ratio of defect lines created by an ultra-short pulsed laser. The high aspect ratio allows creation of a defect line that extends from the top surface to the bottom surface of the substrate material. The present methods also permit formation of defect lines that extend to a controlled depth within the substrate material. The defect line can be created by a single pulse or single burst of pulses, and, if desired, additional pulses or bursts can be used to increase the extension of the affected area (e.g., depth and width).

The generation of a line focus may be performed by sending a Gaussian laser beam into an axicon lens, in which case a beam profile known as a Gauss-Bessel beam is created. Such a beam diffracts much more slowly (e.g. may maintain single micron spot sizes for ranges of hundreds of microns or millimeters as opposed to few tens of microns or less) than a Gaussian beam. Hence the depth of focus or length of intense interaction with the material may be much larger than when using a Gaussian beam only. Other forms or slowly diffracting or non-diffracting beams may also be used, such as Airy beams.

In some cases, the created fault line is not enough to separate the part from the substrate material spontaneously, and a secondary step may be necessary. If desired, a second laser can be used to create thermal stress to separate it, for example. In the case of 0.55 mm thick alkali aluminosilicate glass substrates that are chemically strengthened, separation can be achieved after the creation of a defect line, for example, by application of mechanical force or by using a thermal source (e.g., an infrared laser, for example a CO₂ laser) to create thermal stress and force separation of the part from the substrate material along the fault line. Another option is to use an infrared laser to initiate the separation, and then finish the separation manually. The optional infrared laser separation can be achieved with a focused continuous wave (cw) laser emitting at 10.6 microns and with power adjusted by controlling its duty cycle. Focus change (i.e., extent of defocusing up to and including focused spot size) is used to vary the induced thermal stress by varying the spot size. Defocused laser beams include those laser beams that produce a spot size larger than a minimum, diffraction-limited spot size on the order of the size of the laser wavelength. For example, defocused spot sizes (1/e² diameter) of 2 mm to 20 mm, or 2 mm to 12 mm, or about 7 mm, or about 2 mm and or about 20 mm can be used for CO₂ lasers, for example, whose diffraction-limited spot size is much smaller given the emission wavelength of 10.6 microns.

There are several methods to create the defect line. The optical method of forming the focal line or line focus can take multiple forms, using donut shaped laser beams and spherical lenses, axicon lenses, diffractive elements, or other methods to form the linear region of high intensity. The type of laser (picosecond, femtosecond, etc.) and wavelength (IR, green, UV, etc.) can also be varied, as long as sufficient optical intensities are reached to create breakdown of the substrate material in the region of focus to create breakdown of the substrate material through nonlinear optical effects (e.g., nonlinear absorption, multi-photon absorption).

In the present application, an ultra-short pulsed laser is used to create a high aspect ratio vertical defect line in a consistent, controllable and repeatable manner. The details of the optical setup that enables the creation of this vertical defect line are described below and in U.S. application Ser. No. 14/154,525 filed on Jan. 14, 2014, the entire contents of which are incorporated by reference as if fully set forth herein. The essence of this concept is to use an axicon lens element in an optical lens assembly to create a region of high aspect ratio taper-free microchannels using ultra-short (picoseconds or femtosecond duration) Bessel beams. In other words, the axicon condenses the laser beam into a high intensity region of cylindrical shape and high aspect ratio (long length and small diameter) in the substrate material. Due to the high intensity created with the condensed laser beam, nonlinear interaction of the electromagnetic field of the laser and the substrate material occurs and the laser energy is transferred to the substrate to effect formation of defects that become constituents of the fault line. However, it is important to realize that in the areas of the glass substrate where the laser energy intensity is not high (e.g., substrate surface, volume of substrate surrounding the central convergence line), the substrate is transparent to the laser and there is no mechanism for transferring energy from the laser to the substrate. As a result, nothing happens to the glass substrate when the laser intensity is below the nonlinear threshold.

In some embodiments, the article may include a glass substrate that is provided as a sheet. The glass may be strengthened after being shaped into some embodiments of the article described herein. For example, the glass substrate may be strengthened by any one or more of thermal strengthening, chemical strengthening, and mechanical strengthening or by a combination thereof. In some embodiments, strengthened glass substrates have a compressive stress (CS) layer extending from a surface of the substrate thereof to a compressive stress depth (or depth of compressive stress layer or DOL). The depth of compression is the depth at which compressive stress switches to tensile stress. The region within the glass substrate exhibiting a tensile stress is often referred to as a central tension or CT layer.

Any suitable material may be used for the glass substrates. The glass substrates used to form the articles described herein can be amorphous or crystalline. In this regard, the use of the term “glass” is general and is intended to encompass more than strictly amorphous materials. Amorphous glass substrates according to some embodiments can be selected from soda lime glass, alkali aluminosilicate glass, alkali containing borosilicate glass and alkali aluminoborosilicate glass. Examples of crystalline glass substrates can include glass-ceramics, sapphire or spinel. Examples of glass-ceramics include Li₂O—Al₂O₃—SiO₂ system (i.e. LAS-System) glass ceramics, MgO—Al₂O₃—SiO₂ System (i.e. MAS-System) glass ceramics, glass ceramics including crystalline phases of any one or more of mullite, spinel, α-quartz, β-quartz solid solution, petalite, lithium disilicate, β-spodumene, nepheline, and alumina.

Thermal sagging, as referred to herein, is a process wherein the glass substrate is controllably heated to a temperature such that the glass substrate becomes deformable and sags under its own weight until it touches the mold and takes its shape. This temperature may vary depending on the composition, the size, the shape, micro-structure, pre-processing and post-processing treatment etc.

The temperature ramp profile to heat up the glass substrate at a controlled rate during the thermal sagging process may impact the ease and timing of separation of the 3D shape out of the parent glass substrate. The rate of heating the glass substrate determines the introduced internal thermal stress which in turn causes the perforation cracks of a defect line to propagate and connect with the perforation cracks from the adjacent defect line. The connected perforation cracks offer a path of least resistance to crack propagation and facilitate fracturing or separation of the region of the glass substrate bounded by the contour.

Thermal forming, as referred to herein, is a method including thermal sagging and cooling down of the glass substrate in the mold to form curved 3D glass articles. The rate of cooling the glass substrate may be carefully controlled with a controlled cooling mechanism such as a thermocouple, thermostat or other control devices.

Some embodiments described herein have at least one of many advantages listed below:
i. Process throughput—This laser perforation and sagging separation process of interior thin glass parts is extremely fast as compared to traditional core drill and grinding process. The laser perforation process occurs in 20 sec. vs. traditional finishing would be 5 min.
ii. Full separation and extraction of 3D molded glass parts at the final size—The proposed methods permit complete cutting and extracting of arbitrary shapes (individual or multiple) of molded glass parts.
iii. Reduced subsurface damage—Traditional core drilling causes more stress and deeper (2×) subsurface cracks that result in product rejects than one would experience with the laser cutting process. Due to the ultra-short pulse interaction between laser and material, there is little thermal interaction and thus a minimal heat affected zone that can result in undesirable stress and micro-cracking at the surface and in the subsurface region. In addition, for example, the optics that condense the laser beam into the 3D glass shape create defect lines that are typically 2 to 5 microns in diameter on the surface of the substrate.
iv. Product quality—The proposed method produces high quality separated parts having the same flush surface.
v. Process cleanliness—The methods described above are capable of separating/cutting 3D glass shape in a clean and controlled fashion. It is very challenging to use conventional ablative or thermal laser processes because they tend to trigger heat affected zones that induce micro-cracks and fragmentation of the glass or other substrate into several smaller pieces. The characteristics of the laser pulses and the induced interactions with the material of the disclosed methods can avoid all of these issues because they occur in a very short time scale and because the transparency of the substrate material to the laser radiation minimizes induced thermal effects. Since the defect line is created within the object, the presence of debris and particulate matter during the cutting step is virtually eliminated. If there are any particulates resulting from the created defect line, they are well contained until the part is separated. Particles on surfaces cut and separated by the laser-based methods described herein can have an average diameter less than about 3 microns, for example.
vi. Design flexibility—The present laser processing method allows for cutting/separation of glass and other substrates following many forms and shapes. Tight radii (e.g., <2 mm or <5 mm) may be cut using the methods described herein, allowing curved edges. Also, since the defect lines strongly control the location of any crack propagation, this method gives great control to the spatial location of a cut, and allows for cutting and separation of structures and features as small as a few hundred microns. The process is also capable of creating vertical defect lines in stacked glass panels. It requires that the material be substantially transparent to the laser wavelength, which is the case for 3D glass shapes at the laser wavelength used here (1064 nm).
vii. Elimination of Process Steps—The process to fabricate parts (e.g., arbitrarily shaped glass plates from the incoming glass panel) to the final size and shape involves several steps that encompass cutting the panel, cutting to size, finishing and edge shaping, thinning the parts down to their target thickness, polishing, and even chemically strengthening in some cases. Elimination of any of these steps will improve manufacturing cost in terms of process time and capital expense. The presented methods can reduce the number of steps by, for example, reducing generation of debris and edge defects, potentially eliminating the need for washing and drying stations. Furthermore, the number of steps can be reduced by, for example, cutting the sample directly to its final size, shape and thickness, eliminating a need for finishing lines.

Additional disclosure relevant to forming curved 3D glass articles can be found in US2015/0166394 A1 to Marjanovic et al., entitled “Processing 3D Shaped Transparent Brittle Substrate”; the disclosure of which is incorporated by reference in its entirety.

The figures are not necessarily drawn to scale. The different parts of various figures may have some parts not drawn to scale relative to other parts in order to better illustrate concepts.

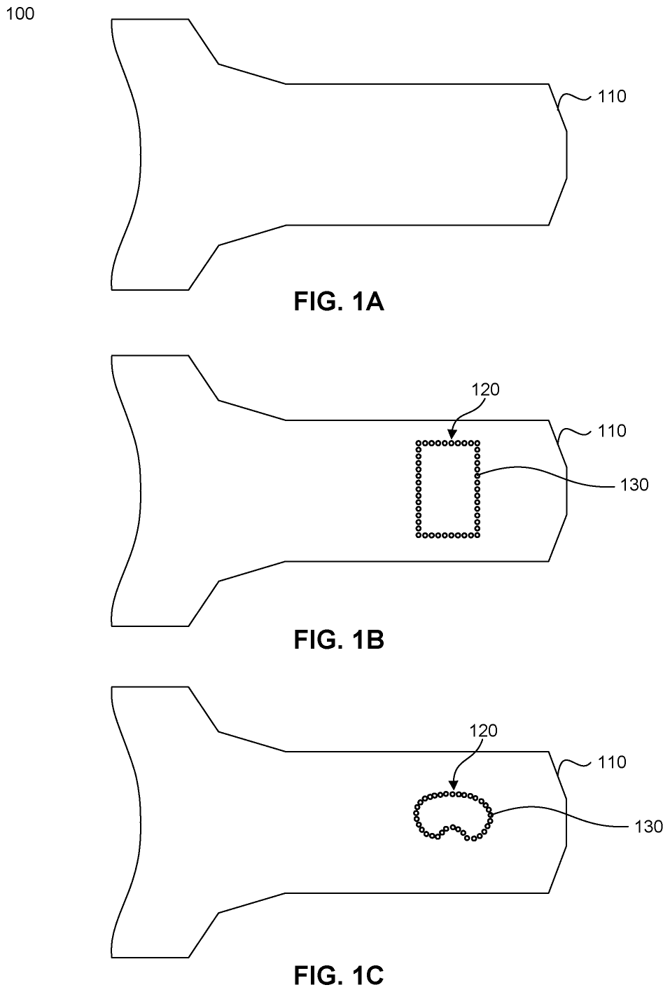

FIG. 1A illustrates a top view of a parent glass substrate 110. The parent glass substrate may be strengthened or non-strengthened, amorphous or crystalline, and optically transparent or almost transparent in the incident laser wavelength range or visible wavelength range.

In some embodiments, the parent glass substrate 110 may have a thickness of 20 μm, 50 μm, 100 μm, 200 μm, 300 μm, 400 μm, 500 μm, 750 μm, 1 mm, 2 mm, 3 mm, 5 mm, 7 mm, 10 mm, 15 mm or any range having any of these two values as endpoints. Other thicknesses may be used. For example, the glass substrate 110 may have a thickness in a range from about 50 μm to about 2 mm, from about 50 μm to about 4 mm, and from about 50 μm to about 6 mm.

In some embodiments, the parent glass substrate 110 may have a rectangular, circular, triangular shape or any combinations thereof.

In some embodiments, the parent glass substrate 110 is planar during the perforating.

FIGS. 1B and 1C illustrate a parent glass substrate 110 with a perforation pattern or contour 120. In some embodiments, the contour 120 has the desired shape of the 3D part to be separated from the parent glass substrate 110. The contour 120 may have a rectangular (as shown in FIG. 1B), a curved (as shown in FIG. 1C), circular, or any shape from a combination thereof.

As used herein, perforating refers to formation of at least a vertical defect line or perforation 130 into the thickness of the glass substrate, by a laser beam directed on the glass substrate.

In some embodiments, a perforation pattern is also referred to as a contour 120 formed by a laser beam, where the perforation path intersects with itself at some location. A series of vertical defect lines or perforations 130 create a contour 120 that delineates the desired shape and establishes a path of least resistance for crack propagation along which separation and detachment of the shape from the parent glass substrate occurs.

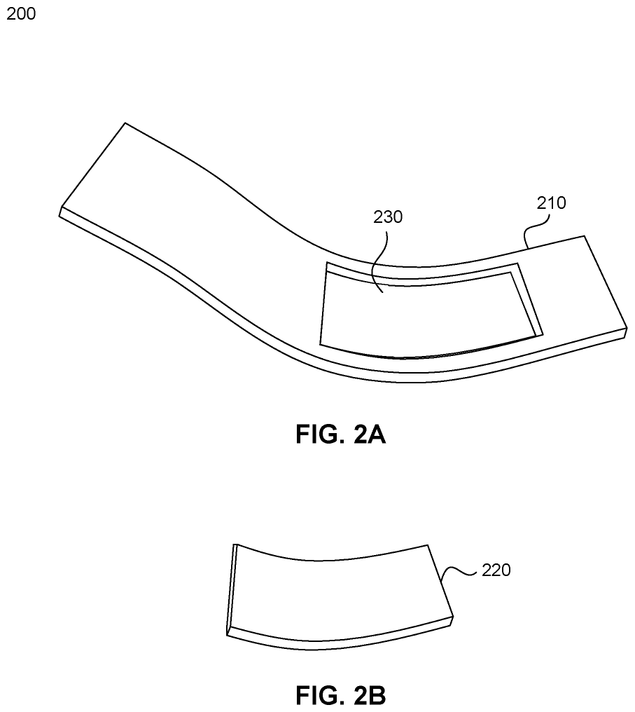

FIGS. 2A and 2B illustrate a 3D view 200 of the final curved 3D glass article with an opening, created by separating the first portion of the glass substrate 220 (also referred to as “slug”) from the second portion of the glass substrate 210. The perforation pattern or the contour 120 defines the shape and the boundaries of the first portion of the glass substrate 220.

In some embodiments, an “opening”, as referred to herein, is defined as a region of absence of the parent glass material, bounded on all sides by the second portion of the glass substrate 210.

In some embodiments, the contour 120 forms an opening 230 in the second portion of the glass substrate 210 after the first portion 220 is separated.

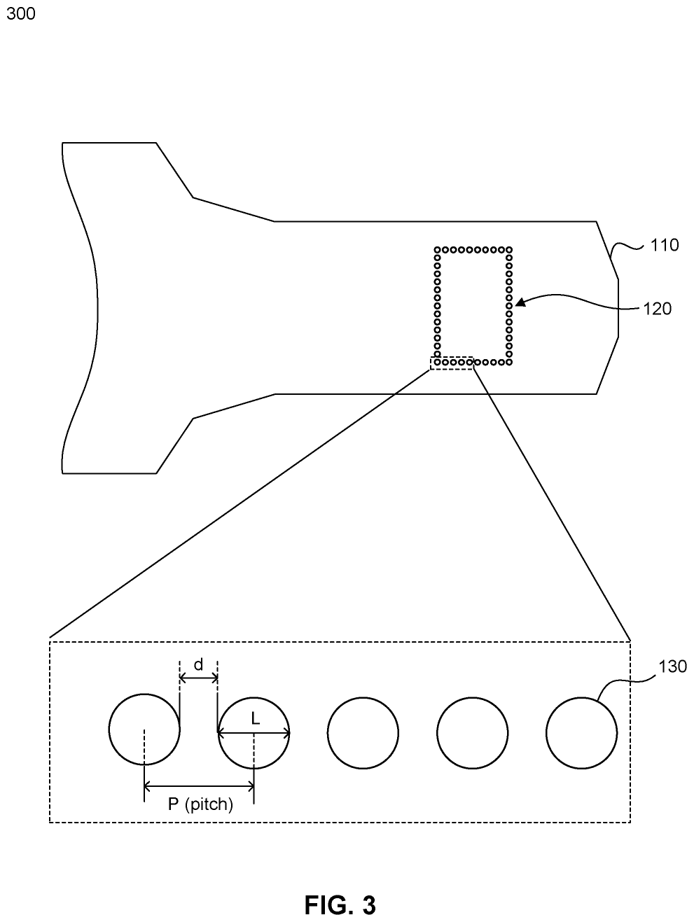

FIG. 3 shows a top view 300 of the glass substrate with a contour 120 and an enlarged view of a series of vertical defect lines or perforations 130. For ease of illustration and explanation purposes, the perforations 130 are shown to have a circular cross-section. The dimensions illustrated in FIG. 3 include:
i. Perforation size (L)—is the dimension of the perforation along the direction of the contour 120. In the case of circular perforations arranged in a line, this definition of perforation size corresponds to the diameter of the perforation 130. Separation distance (d)—is the length of the solid glass material present between the two nearest points on the circumference of two adjacent perforations 130, along the direction of the contour 120.
ii. Pitch (P)—is the distance between the center points of two adjacent perforations 130, along the direction of the contour 120. In some embodiments, wherein all the perforations along the direction of the contour are circular and have an equal diameter, pitch can also be defined as the sum of separation distance (d) and the perforation size (L).

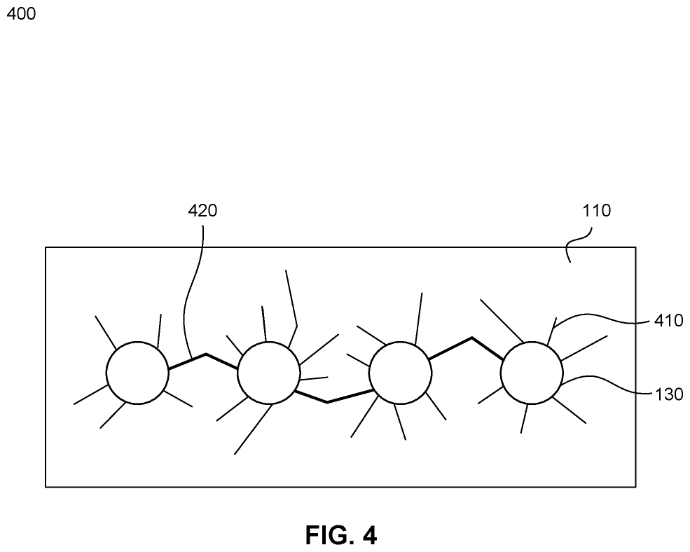

FIG. 4 illustrates a top view 400 of a series of perforations 130 and radial perforation cracks 410 at each perforation position, induced by the laser beam. The perforation cracks 410 in the substrate 110 may be regarded as micro-cracks and typically originate from any given point on the circumference of a perforation. The perforation cracks 410 may be regarded as structural defects that mechanically weaken the glass substrate 110 and render it more susceptible to cracking or fracturing under mechanical or thermal stress.

A network of micro-cracks or perforation cracks 410 of varied lengths and depths into the glass substrate may be formed based on the laser energy, duration, scan rate, intensity, etc. The radial perforation cracks 410 may be linked between two adjacent perforations 130 creating a continuous path of least resistance for crack propagation, as illustrated by linkage 420 in FIG. 4. The linkage 420 along the contour 120 defines the shape and the boundary of the first portion of the glass substrate 220 to be separated from the second portion of the glass substrate 210. The radial perforation cracks 410 may be planar or non-planar. Planar radial perforation cracks extend along a given plane of the glass substrate and non-planar radial perforation cracks extend along multiple planes through the thickness of the glass substrate.

The amount of radial perforation crack damage may affect the timing of separation of the first portion of the glass substrate 220 during the thermal sagging process. Deeper radial perforation cracks will cause separation even before the thermal sagging process. Radial perforation cracks that are too small will not separate at all. The key in optimizing the radial perforation crack damage is to extend the radial cracks at the right time of the thermal sagging process.

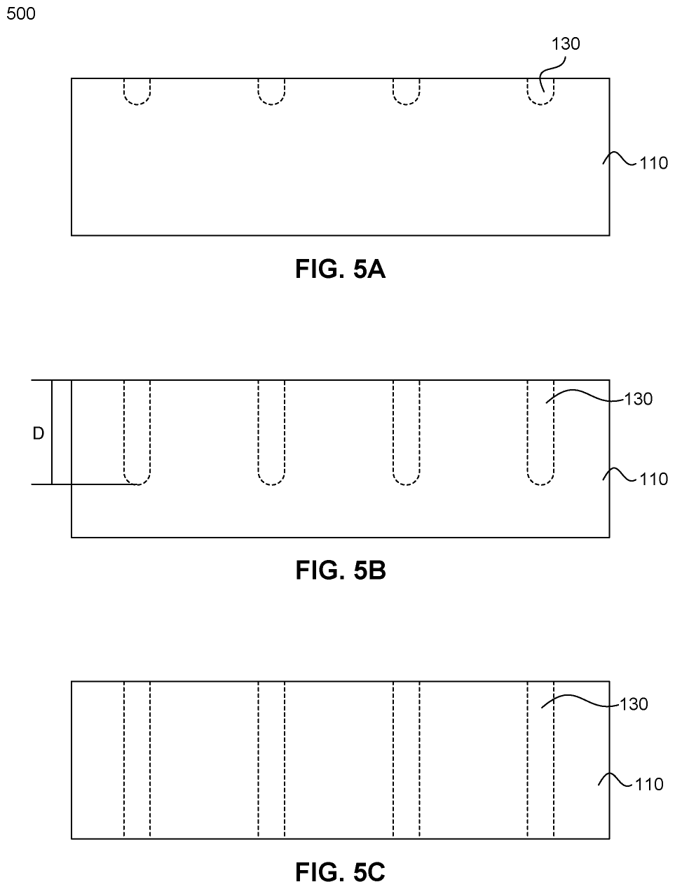

FIGS. 5A-5C illustrate a cross-section view 500 of the glass substrate 110 with varying depths, D of the perforations 130. The perforations 130 extend into the interior of the glass substrate 110 and have a cross-sectional shape consistent with the cross-sectional shape of the laser beam (generally circular). In some embodiments, the perforations 130 are a “through hole”, which is a hole or an open channel that extends from the top to the bottom of the glass substrate 110, as illustrated in FIG. 5C. In some embodiments, the perforation may not be a continuously open channel and may include sections of solid material dislodged from the glass substrate material by the laser beam to varying depths, as illustrated in FIGS. 5A and 5B.

In some embodiments, the depth (D) of the defect line or the perforation 130, into the interior of the glass substrate is 0.1% of the total thickness of the glass substrate, 5% of the total thickness of the glass substrate, 10% of the total thickness of the glass substrate, 20% of the total thickness of the glass substrate, 40% of the total thickness of the glass substrate, 60% of the total thickness of the glass substrate, 80% of the total thickness of the glass substrate, 100% of the total thickness of the glass substrate, or any range having any of these two values as endpoints.

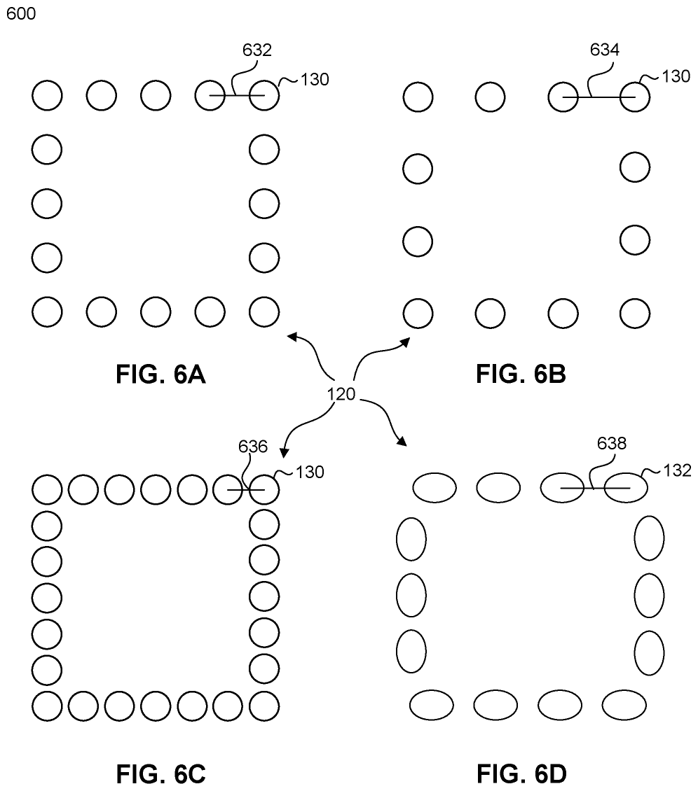

FIGS. 6A-6C illustrate some of the various permutations of pitch (P) of the circular (exemplary) perforations along an exemplary rectangular contour 120. The ease and the timing of the separation of the first portion of the glass substrate along the contour 120 may also be determined by the pitch (P) of the perforations.

In some embodiments, the pitch (P) of the perforations 130 may be an optimized distance 632, as illustrated in FIG. 6A.

In some embodiments, the pitch (P) of the perforations 130 may be larger, 634, as illustrated in FIG. 6B. The larger pitch 634 may delay the separation or the separation may not occur at all due to the inability of the cracks to propagate and connect to form a linkage 420.

In some embodiments, the pitch (P) of the perforations 130 may be smaller, 636, as illustrated in FIG. 6C. The smaller pitch 634 may cause the separation to occur before the thermal sagging process since the perforation cracks from two adjacent perforations could easily link to form a continuous path of structural defects along which the separation may occur.

In some embodiments, the pitch (P) of the perforations 130 or the non-circular perforations 132, is 0.25 μm, 0.5 μm, 2 μm, 3 μm, 4 μm, 5 μm, 7 μm, 10 μm, 15 μm, 20 μm, 30 μm, 50 μm, 100 μm, or any range having any of these two values as endpoints.

In some embodiments, the separation distance (d) or the spacing between the two nearest points on the circumference of the perforations 130 or the non-circular perforations 132, along the direction of the contour, is 0.1 μm, 0.25 μm, 0.5 μm, 2 μm, 3 μm, 4 μm, 5 μm, 7 μm, 10 μm, 15 μm, 20 μm, 30 μm, 50 μm, or any range having any of these two values as endpoints.

In some embodiments, the separation distance (d) is in the range of 1 μm to 3 μm, 3 μm to 4 μm, 4 μm to 6 μm, 6 μm to 8 μm, 8 μm to 10 μm, 10 μm to 15 μm.

In some embodiments, the perforation size (L) or the average diameter of the perforations 130, is 0.1 μm, 0.2 μm, 0.5 μm, 2 μm, 5 μm, 10 μm, 20 μm, 30 μm, 40 μm, 50 μm, 100 μm, or any range having any of these two values as endpoints.

In some embodiments, the shape of the first portion of the glass substrate is round, oval, rectangle, triangle, or a combination thereof.

In some embodiments, the perforations have a non-circular cross-section 132 and a pitch 638, as illustrated in FIG. 6D. The non-circular cross-section may also include oval, oblong, elliptical, triangular, rectangular, or any combinations thereof.

In some embodiments, the contour 120 may be formed by a series of perforations of varying cross-sections, pitch, separation distance and perforation size, or combinations thereof to produce the desired 3D shape of the first portion of the glass substrate 220.

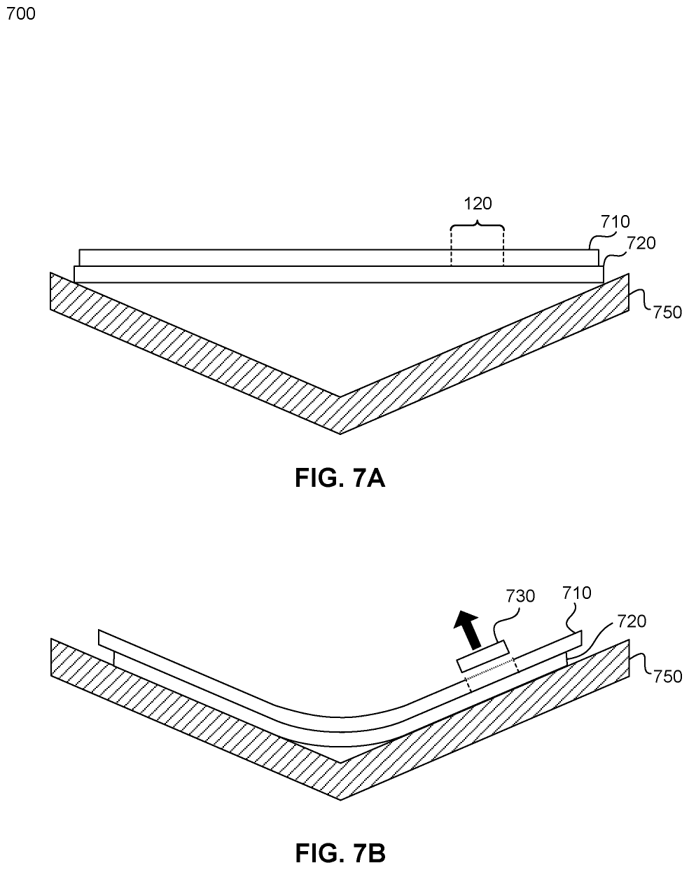

FIG. 7A illustrates a cross-section view of the assembly of the laser perforated glass substrate 710 and the sacrificial glass substrate 710, placed on the non-planar mold 750. The cross-section view of the laser perforation on the parent glass substrate forming a contour 120 is also depicted.

In some embodiments, a glass substrate 710 is disposed on a sacrificial glass substrate 720. The sacrificial glass substrate 720 is preferably the same size and same material as the glass substrate 710 to minimize or eliminate stresses due to thermal coefficient of expansion mismatch during the thermal sagging or the cooling down process steps.

In some embodiments, the glass substrate 710 may be laser perforated prior to disposing on the sacrificial glass substrate 720. The sacrificial glass substrate 720 and the laser perforated glass substrate 710 may be assembled prior to placing in the mold. Alternatively, the perforated glass substrate 710 may be disposed on the sacrificial glass substrate 720 after placing the sacrificial glass substrate 720 in the mold 750.

In some embodiments, the glass substrate 710 may be laser perforated after disposing on the sacrificial glass substrate 720 but prior to placing in the mold 750. The laser perforation process parameters may be adjusted to control the perforation depth D such that the sacrificial glass substrate 720 is not damaged or ablated by the laser beam while accomplishing the desired perforation depth D in the parent glass substrate 710.

In some embodiments, the assembly of the sacrificial glass substrate 720 and the glass substrate 710 is heated to a temperature such that the viscosity of the glass material in the glass substrate and the sacrificial glass substrate is 10⁷ poise, 10⁸ poise, 10⁹ poise, 10¹⁰ poise, 10¹¹ poise, 10¹² poise, 10¹³ poise, or any range having any of these two values as endpoints. Other viscosities may be used.

In some embodiments, the viscosity of the glass material in the glass substrate and the sacrificial glass substrate is in the range of 10⁸ to 10¹² poise.

FIG. 7B illustrates the thermal sagging of the assembly of the laser perforated glass substrate 710 and the sacrificial glass substrate 720, and pulling the slug 730, analogous to the first portion of the glass substrate 220, away from the mold 750 after separating from the glass substrate 710.

The utilization of a sacrificial glass substrate has several advantages, some of which are listed below:
i. Prevents premature drop-out of the first portion of the glass substrate.
ii. Acts as a support structure to avoid preferential kinking of the parent glass substrate.
iii. Enhances longevity of molds, which could be expensive to replace or re-finish.
iv. Protects the mold surface from generated debris.
v. Preserves the pristine surface of the mold to avoid structural and surface imperfections in the final product.

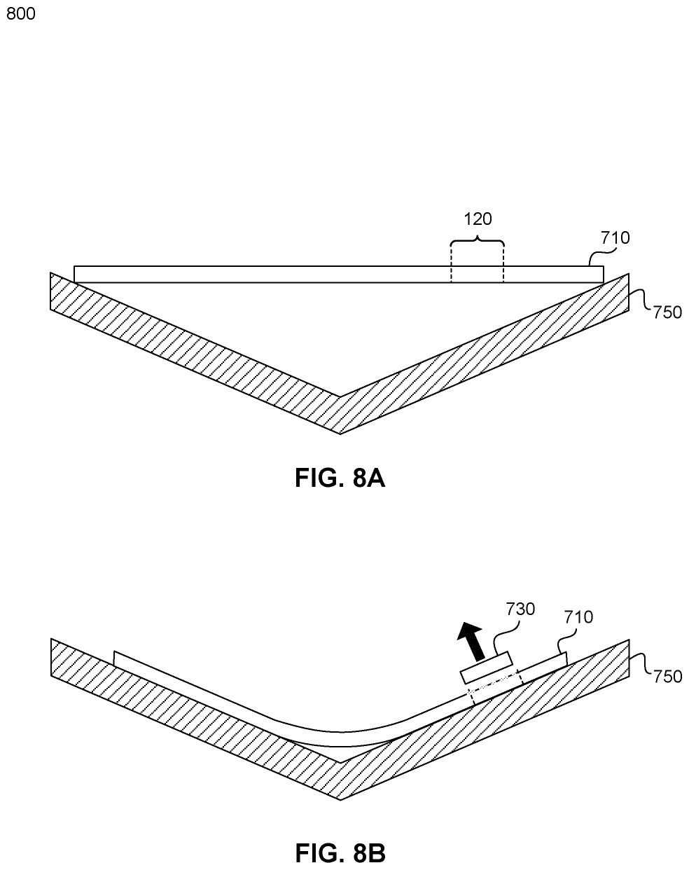

FIG. 8A illustrates a cross-section view 800 of the glass substrate 710 placed directly on the mold 750, without a sacrificial glass substrate. FIG. 8B illustrates thermally sagging the glass substrate 710 into the mold 750, and pulling the slug 730 away from the mold 750 after separating from the glass substrate 710.

In some embodiments, the first portion of the glass substrate 220 separates from the second portion of the glass substrate 210 during thermal forming. The separation distance (d) between two adjacent perforations 130 may affect the separation of the first part of the glass substrate 220 from the second portion of the glass substrate 210. If the separation distance (d) is too small, typically <3 μm, the separation may occur even before the thermal sagging. On the other hand, if the separation distance (d) is too large, typically >6 μm, the separation may take too long or not occur at all. The optimum range for the separation distance (d) is typically 4-6 μm, where the separation may occur at the start of the thermal sagging process.

In some embodiments, the first portion of the glass substrate 220 separates from the second portion of the glass substrate 210 by applying pressure. Applying the pressure is accomplished by a pressure application device. The pressure applied to separate the first portion of the glass substrate 220 separates from the second portion of the glass substrate 210 may be a positive or a negative pressure. In some embodiments, the pressure to separate the first portion of the glass substrate 220 from the second portion of the glass substrate 210 may be applied by pushing or pulling.

In some embodiments, separating the first portion of the glass substrate 220 from the second portion of the glass substrate 210 comprises pulling the first portion of the glass substrate 220, analogous to the slug 730, away from the mold 750, as illustrated in FIG. 8B.

In some embodiments, pulling the slug 730, analogous to the first portion of the glass substrate 220, away from the mold may be accomplished with a suction device. A suction device may be a device that utilizes vacuum to create suction. The vacuum may be generated by mechanical, battery-operated, electrical mechanisms, or any combinations thereof. In some embodiments, the suction device has a suction cup or a tip at one end that contacts the first portion of the glass substrate. Under vacuum, the slug 730 is held by suction or the negative pressure between the tip of the suction device and the first portion of the glass substrate.

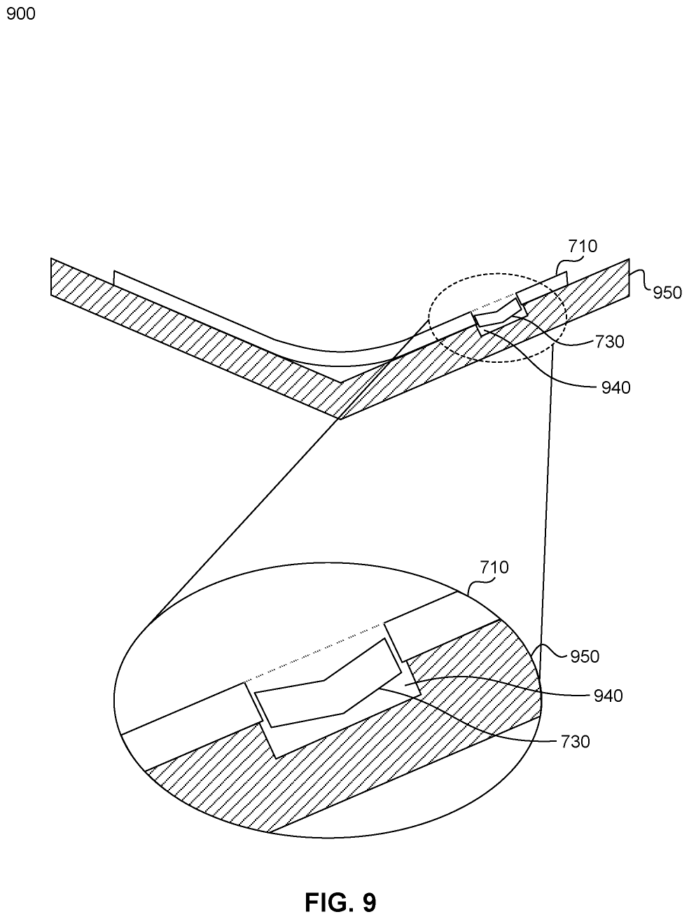

In some embodiments, separating the first portion of the glass substrate from the second portion of the glass substrate comprises pulling the first portion of the glass substrate into a recess 940 in the single-recess mold 950, as illustrated in view 900 of FIG. 9. The dotted area is represented in an enlarged view for clarity of illustration. The mold 950 may have a portion cut-out to create a recess 940 such that the slug 730, analogous to the first portion of the glass substrate, can be pulled into the recess 940, after separating from the glass substrate 710.

In some embodiments, the first portion of the glass substrate is separated from the second portion of the glass substrate by pushing the first portion of the glass substrate away from the mold.

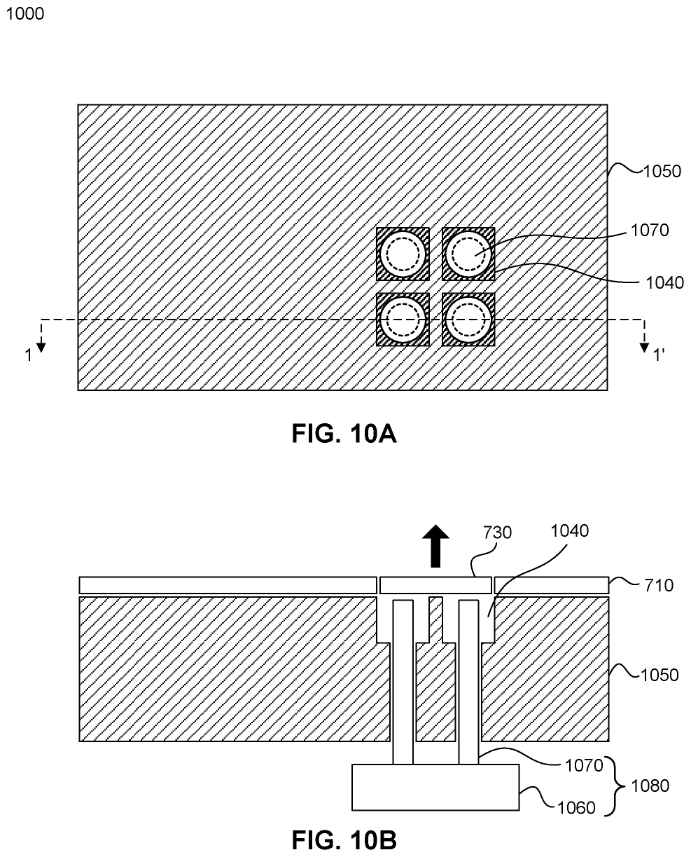

FIG. 10A illustrates a top view 1000 of an exemplary multi-recessed mold 1050 with multiple recesses 1040 arranged in a rectangular shape. A cross-section view of the mold 1050 along the 1-1′ plane is shown in FIG. 10B.

FIG. 10B illustrates a “pushing-away-from-the-mold” approach of separating the slug 730 from the second portion of the glass substrate 710. The molds may be designed to have a single recess, such as the single-recess mold 950 or multiple recesses, such as the multi-recessed mold 1050, based on the design of the final product. A multi-recessed mold 1050 with recesses in locations corresponding to the location of the openings 230 in the glass substrate may be used to form the final 3D curved glass article.

In some embodiments, the recesses 1040 in the mold 1050 may be regarded as cavities that may be created by a variety of methods including drilling, CNC machining, laser drilling, boring, or other suitable techniques.

In some embodiments, the slug 730 may be pushed away from the mold 1050 to separate from the glass substrate 710 using a pressure application device 1080 including a pressure application chamber 1060 and ejector pin(s) 1070.

In some embodiments, the ejector pin(s) 1070 are extendable and retractable. The ejector pin(s) 1070 may be retracted during the thermal sagging process or the thermal forming process. The ejector pin(s) 1070 may be extended through the thickness of the mold towards the glass substrate to push the slug 730 away from the mold 1050, after separation of the first portion from the second portion of the glass substrate 710.

In some embodiments, the operating mechanism of the pressure application device 1080 may be hydraulic, pneumatic, electrical, mechanical, or a combination thereof. In some embodiments, the pressure application device 1080 is a portable, stand-alone unit or a hand-held unit that is battery operated or electrically operated.

In some embodiments, the ejector pin(s) 1070 may have a circular, rectangular, triangular cross-section or a combination thereof.

In some embodiments, the ejector pin(s) 1070 may be made of a material selected from the group of metals, ceramics, polymers, glass, or a combination thereof.

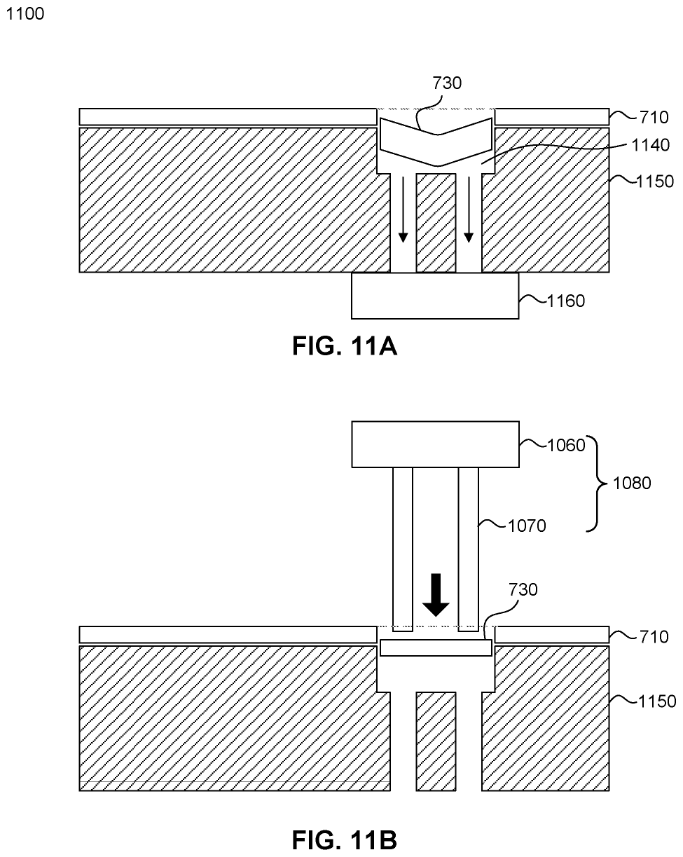

FIG. 11A illustrates a “pulling-into-the-mold” approach of separating the slug 730 from the glass substrate 710. The pressure may be applied through a vacuum chamber 1160. Under vacuum, the slug 730 may be separated from the glass substrate 710 by pulling into the recess 1140 in the cooled mold 1150 during the cool down process. The vacuum may be applied only to the slug 730 during the cool down process, causing the slug 730 to cool at a faster rate than the rest of the glass substrate 710. The differential cooling rate causes the slug 730 to contract in size and deform into a concave shape, extending the radial perforation cracks such that a linkage is formed between perforation cracks of adjacent perforations. The linked perforation cracks may form a continuous linkage 420 representing structural weakness in the glass substrate 710 which allows the separation to occur along the path of the linked perforation cracks.

In some embodiments, a linkage 420 between the perforation cracks 410 of adjacent perforations in the glass substrate may be formed before thermal sagging. Separation may still occur during thermal sagging if the linkage formed prior to thermal sagging does not result in a first portion of the glass substrate 220, analogous to the slug 730, that may be cleanly slid out from second portion of the glass substrate 210. For example, the linkage may have some roughness that inhibits separation prior to thermal forming.

In some embodiments, the vacuum chamber 1160 may be a mechanically, electrically, pump-operated, or a battery-operated hand held vacuum device. Once the slug 730 is separated and pulled into the recess 1140 of the cooled mold 1150, the slug 730 may be pulled out of the mold.

FIG. 11B illustrates a “pushing-into-the-mold” approach of separating the first portion of the glass substrate 220 from the second portion of the glass substrate 210. The pressure application chamber 1060 and the ejector pins 1070 may also be used to push the slug 730 into the recess 1140.

In some embodiments, the first portion of the glass substrate is preferentially cooled to shrink in size before separating from the second portion of the glass substrate. The thermal gradient between the first portion and the second portion of the glass substrate induces tensile stress in the glass substrate and enhances crack propagation.

In some embodiments, the rate of preferentially cooling the first portion of the glass substrate may impact the separation timing, ease and the structural imperfections in the final product. The rate of preferentially cooling the slug 730 may be 20° C. per minute, 40° C. per minute, 60° C. per minute, 100° C. per minute, 200° C. per minute, or any range having any of these two values as endpoints, or any open-ended range without an upper bound having one of these values as the lower endpoint. Other rates may be used.

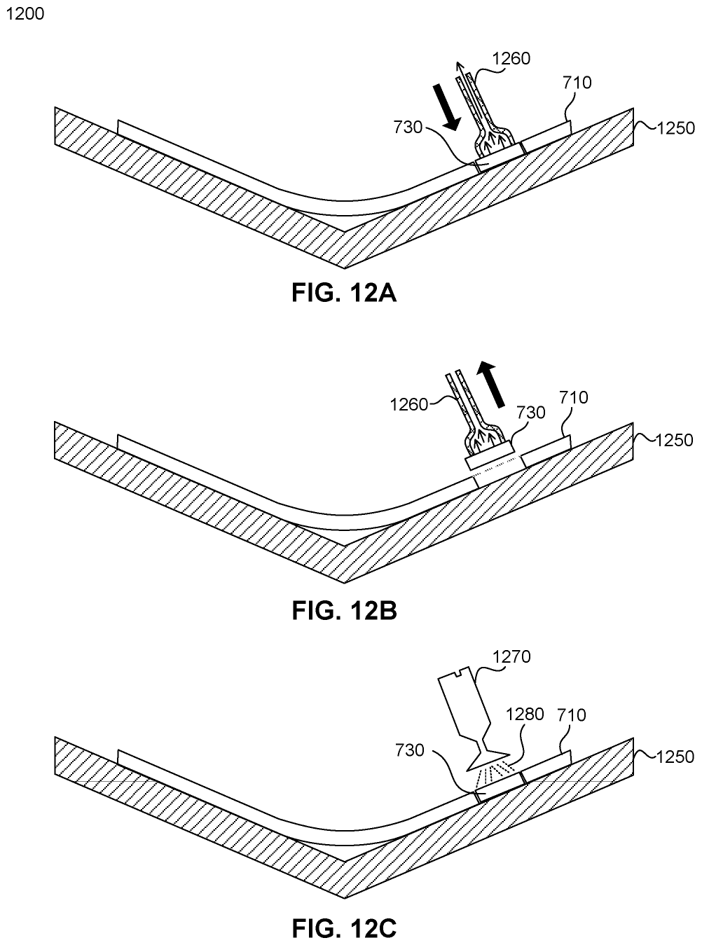

FIGS. 12A-12C illustrate a “pulling-away-from-the-mold” approach of separating the slug 730 from the glass substrate 710. FIG. 12A shows the cooling-and-pressure application device 1260 in contact with the slug 730. In some embodiments, the cooling device and pressure application device are separate devices and may be used separately or in conjunction to separate the slug 730 from the glass substrate 710.

In some embodiments, preferentially cooling the first portion of the glass substrate is accomplished with contacting the first portion with a cooling device. A pressure application device may also serve as a cooling device to cool the first portion of the glass substrate. The cooling-and-pressure application device 1260 may be a water-cooled or gas-cooled vacuum device.

In some embodiments, the tip of the cooling-and-pressure application device 1260 in contact with the slug 730 is smaller in size than the slug 730.

In some embodiments, a pressure application chamber 1060 (not illustrated in the figure) may be attached to the cooling-and-pressure application device 1260 on the opposite end of its tip to assist with pulling of the slug 730 away from the mold.

FIG. 12B illustrates the separated slug 730 held by the cooling-and-pressure application device 1260 through suction, while being pulled away from the mold 1250. In some embodiments, the cooling-and-pressure application device 1260 may push the slug 730 into a recess in the mold 1250 (not illustrated).

In some embodiments, before separation of the slug 730, the area of the mold supporting the first portion of the glass substrate is preferentially cooled. The mold 1250 may be preferentially cooled by recirculating a coolant through the thickness of the mold. (not illustrated in FIGS. 12A-12C) The recirculating coolant may be a liquid, a gas, or a solvent, a heat-exchanging fluid, or any combination thereof.

In some embodiments, a stream of cool air 1280 may be directed at the first portion of the glass substrate through a cooling device 1270. The cooling device 1270 may be held in close proximity to the first portion of the glass substrate, analogous to slug 730, so as to preferentially cool the slug 730. The thermal gradient between the first portion and the second portion of the glass substrate 710 induces tensile stress causing the perforation cracks 410 to extend, forming a linkage 420 connecting the cracks along the contour to cause complete separation of the slug 730 from the glass substrate 710.

In some embodiments, a pressure application device or a pressure application chamber may be attached to the cooling device 1270 to push or pull the first portion of the glass substrate away or into the mold 1250 once complete separation from the glass substrate 710 is accomplished.

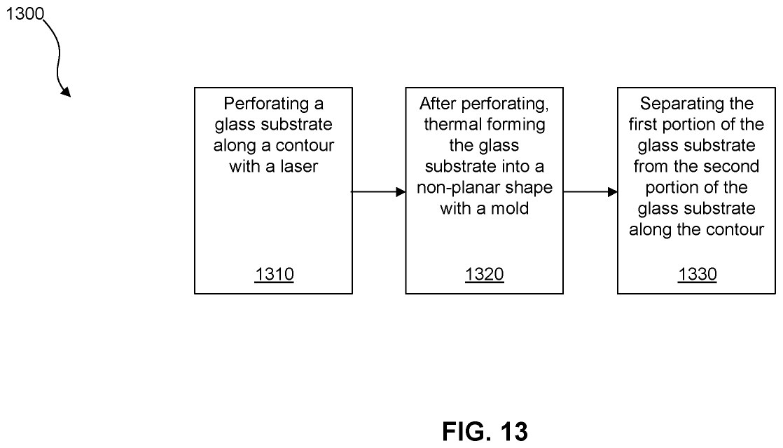

FIG. 13 shows an exemplary process flowchart for a laser perforating and thermal sagging process for 3D glass articles with an opening. The following steps are performed:

Step 1310: perforating a glass substrate 110 along a contour 120 with a laser;

Step 1320: after perforating, thermal forming the glass substrate into a non-planar shape with a mold 750; and

Step 1330: separating the first portion of the glass substrate 220 from the second portion of the glass substrate 210 along the contour 120.

In some embodiments, perforating a glass substrate 110 along the contour 120 separates or delineates a first portion of the glass substrate 220 from a second portion of the glass substrate 210.

In some embodiments, separating the first portion of the glass substrate 220 from the second portion of the glass substrate 210 along the contour 120 may occur before, during or after thermal forming the glass substrate into a non-planar shape with the mold 750. FIG. 13 shows a process flowchart as an example wherein separating the first portion from the second portion of the glass substrate is performed after thermal forming the glass substrate into a non-planar shape.

In some embodiments, preferential cooling of first portion of the glass substrate 220 relative to second portion of the glass substrate 210 is not needed, and is not performed. For example, temperature changes that occur after the glass substrate cools after thermal forming may be adequate to cause separation of first portion of the glass substrate 220 relative to second portion of the glass substrate 210.

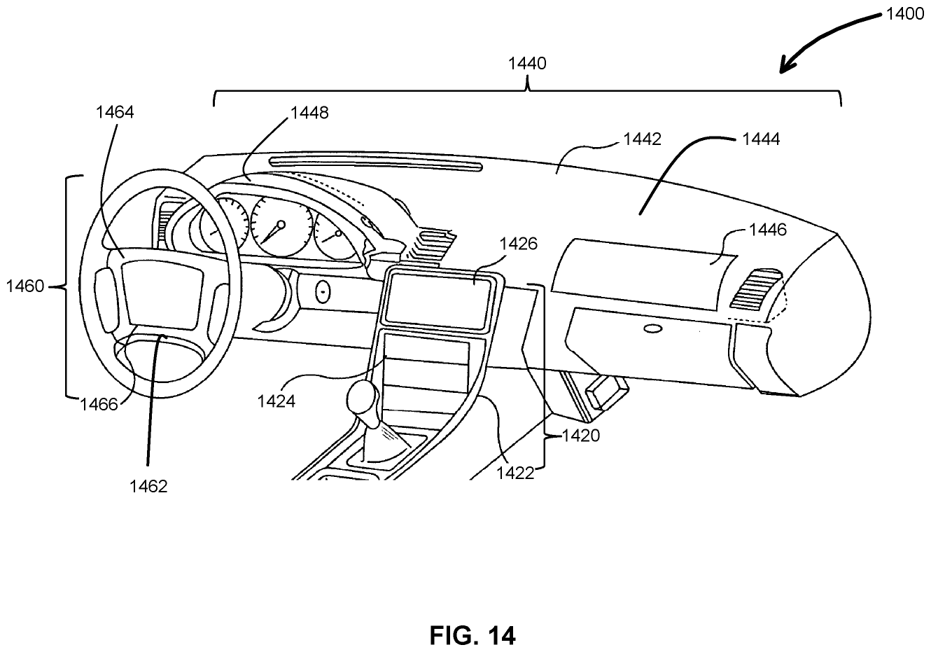

FIG. 14 is a perspective view illustration of a vehicle interior with vehicle interior systems according to one or more embodiments.

FIG. 14 illustrates an exemplary vehicle interior 1400 that includes three different embodiments of a vehicle interior system 1420, 1440, 1460. Vehicle interior system 1420 includes a center console base 1422 with a curved surface 1424 including a curved display 1426. Vehicle interior system 1440 includes a dashboard base 1442 with a curved surface 1444 including a curved display 1446. The dashboard base 1442 typically includes an instrument panel 1448 which may also include a curved display. Vehicle interior system 1460 includes a dashboard steering wheel base 1462 with a curved surface 1464 and a curved display 1466. In one or more embodiments, the vehicle interior system may include base that is an arm rest, a pillar, a seat back, a floor board, a headrest, a door panel, or any portion of the interior of a vehicle that includes a curved surface.

The embodiments of the curved display described herein can be used interchangeably in each of vehicle interior systems 1420, 1440 and 1460.

Aspect (1) of this disclosure pertains to a method of forming a glass article, the method comprising: perforating a glass substrate along a contour with a laser forming a plurality of perforations, such that the contour separates a first portion of the glass substrate from a second portion of the glass substrate; after perforating: thermal forming the glass substrate into a non-planar shape with a mold; and separating the first portion of the glass substrate from the second portion of the glass substrate.

Aspect (2) of this disclosure pertains to the method of Aspect (1), wherein the contour forms an opening in the glass article after the first portion is separated.

Aspect (3) of this disclosure pertains to the method of Aspect (1) or Aspect (2), further comprising, before separating, shrinking the first portion of the glass substrate relative to the second portion of the glass substrate by preferentially cooling the first portion.

Aspect (4) of this disclosure pertains to the method of Aspect (3), wherein preferentially cooling the first portion comprises contacting the first portion with a cooling device.

Aspect (5) of this disclosure pertains to the method of Aspect (3) or Aspect (4), wherein preferentially cooling the first portion comprises directing cool air at the first portion.

Aspect (6) of this disclosure pertains to the method of Aspect (1) or Aspect (2), wherein separating comprises applying pressure during separating the first portion of the glass substrate from the second portion of the glass substrate.

Aspect (7) of this disclosure pertains to the method of Aspect (6), wherein applying pressure is accomplished with a pressure application device, and the pressure application device preferentially cools the first portion.

Aspect (8) of this disclosure pertains to the method of Aspect (6) or Aspect (7), wherein the pressure is applied by pulling.

Aspect (9) of this disclosure pertains to the method of Aspect (6) or Aspect (7), wherein the pressure is applied by pushing.

Aspect (10) of this disclosure pertains to the method of Aspect (1) or Aspect (2), wherein separating the first portion of the glass substrate from the second portion of the glass substrate comprises pulling the first portion of the glass substrate away from the mold.

Aspect (11) of this disclosure pertains to the method of Aspect (10), wherein pulling the first portion of the glass substrate away from the mold is accomplished with a suction device.

Aspect (12) of this disclosure pertains to the method of Aspect (1) or Aspect (2), wherein separating the first portion of the glass substrate from the second portion of the glass substrate comprises pulling the first portion of the glass substrate into a recess in the mold.

Aspect (13) of this disclosure pertains to the method of any one of Aspects (1) through (5), wherein the first portion of the glass substrate separates from the second portion of the glass substrate during thermal forming.

Aspect (14) of this disclosure pertains to the method of any one of Aspects (1) through (13), further comprising separating the first portion of the glass substrate from the second portion of the glass substrate after thermal forming.

Aspect (15) of this disclosure pertains to the method of any one of Aspects (1) through (14), wherein the glass substrate is flat during the perforating.

Aspect (16) of this disclosure pertains to the method of any one of Aspects (1) through (15), wherein thermal forming the glass substrate comprises thermal sagging the glass substrate into the mold by heating the glass substrate to a temperature at which the glass substrate sags under its own weight.

Aspect (17) of this disclosure pertains to the method of any one of Aspects (1) through (16), further comprising: disposing the glass substrate on a sacrificial glass substrate prior to thermal forming; thermal forming the glass substrate and the sacrificial glass substrate into the non-planar shape with the mold; separating the first portion of the glass substrate from the second portion of the glass substrate; and separating the glass substrate from the sacrificial glass substrate.

Aspect (18) of this disclosure pertains to the method of any one of Aspects (1) through (17), wherein the spacing between two adjacent perforations is 1 μm to 10 μm.

Aspect (19) of this disclosure pertains to the method of any one of Aspects (1) through (18), wherein the shape of the first portion of the glass substrate is selected from the group consisting of round, oval, rectangle, and triangle.

Aspect (20) of this disclosure pertains to the method of any one of Aspects (1) through (19), wherein the glass substrate has a thickness 50 μm to 2 mm.

Aspect (21) of this disclosure pertains to the method of any one of Aspects (1) through (20), wherein the depth of the perforations is 5% to 100% of the thickness of the glass substrate.

Aspect (22) of this disclosure pertains to the method of any one of Aspects (1) through (21), wherein the laser is a pico-second laser.

Aspect (23) of this disclosure pertains to an article, formed by a method comprising: perforating a glass substrate along a contour with a laser forming a plurality of perforations, such that the contour separates a first portion of the glass substrate from a second portion of the glass substrate; after perforating: thermal forming the glass substrate into a non-planar shape with a mold; and separating the first portion of the glass substrate from the second portion of the glass substrate.

Aspect (24) of this disclosure pertains to a vehicle interior system comprising: a base including a curved surface; and the article of claim 23 disposed on the curved surface.

Aspect (25) of this disclosure pertains to the vehicle interior system of Aspect (24), wherein the contour forms an opening in the glass substrate after the first portion is separated, and the curved surface comprises any one of a button, knob and vent, that is accessible through the opening.

Aspect (26) of this disclosure pertains to the vehicle interior system of Aspect (24) or Aspect (25), wherein the base further comprises a display.

Aspect (27) of this disclosure pertains to the vehicle interior system of Aspect (26), wherein the display is visible through the opening.

Aspect (28) of this disclosure pertains to the vehicle interior system of Aspect (26), wherein the display is visible through the second portion.

Aspect (29) of this disclosure pertains to the vehicle interior system of any one of Aspects (24) through (28), wherein the vehicle is any one of an automobile, a seacraft, and an aircraft.

Embodiments of the present disclosure are described in detail herein with reference to embodiments thereof as illustrated in the accompanying drawings, in which like reference numerals are used to indicate identical or functionally similar elements. References to “one embodiment,” “an embodiment,” “some embodiments,” “in certain embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Where a range of numerical values is recited herein, comprising upper and lower values, unless otherwise stated in specific circumstances, the range is intended to include the endpoints thereof, and all integers and fractions within the range. It is not intended that the scope of the claims be limited to the specific values recited when defining a range. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed. Finally, when the term “about” is used in describing a value or an end-point of a range, the disclosure should be understood to include the specific value or end-point referred to. Whether or not a numerical value or end-point of a range recites “about,” the numerical value or end-point of a range is intended to include two embodiments: one modified by “about,” and one not modified by “about.”

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

As used herein, “comprising” is an open-ended transitional phrase. A list of elements following the transitional phrase “comprising” is a non-exclusive list, such that elements in addition to those specifically recited in the list may also be present.

The term “or,” as used herein, is inclusive; more specifically, the phrase “A or B” means “A, B, or both A and B.” Exclusive “or” is designated herein by terms such as “either A or B” and “one of A or B,” for example.

The indefinite articles “a” and “an” to describe an element or component means that one or at least one of these elements or components is present. Although these articles are conventionally employed to signify that the modified noun is a singular noun, as used herein the articles “a” and “an” also include the plural, unless otherwise stated in specific instances. Similarly, the definite article “the,” as used herein, also signifies that the modified noun may be singular or plural, again unless otherwise stated in specific instances.

The term “wherein” is used as an open-ended transitional phrase, to introduce a recitation of a series of characteristics of the structure.

The examples are illustrative, but not limiting, of the present disclosure. Other suitable modifications and adaptations of the variety of conditions and parameters normally encountered in the field, and which would be apparent to those skilled in the art, are within the spirit and scope of the disclosure.

While various embodiments have been described herein, they have been presented by way of example only, and not limitation. It should be apparent that adaptations and modifications are intended to be within the meaning and range of equivalents of the disclosed embodiments, based on the teaching and guidance presented herein. It therefore will be apparent to one skilled in the art that various changes in form and detail can be made to the embodiments disclosed herein without departing from the spirit and scope of the present disclosure. The elements of the embodiments presented herein are not necessarily mutually exclusive, but may be interchanged to meet various needs as would be appreciated by one of skill in the art.

It is to be understood that the phraseology or terminology used herein is for the purpose of description and not of limitation. The breadth and scope of the present disclosure should not be limited by any of the above-described exemplary embodiments, but should be defined only in accordance with the following claims and their equivalents.

1. A method of forming a glass article, the method comprising:
perforating a glass substrate along a contour with a laser forming a plurality of perforations, such that the contour separates a first portion of the glass substrate from a second portion of the glass substrate;
after perforating:
thermal forming the glass substrate into a non-planar shape with a mold; and
separating the first portion of the glass substrate from the second portion of the glass substrate.

2. The method of claim 1, wherein the contour forms an opening in the glass article after the first portion is separated.

3. The method of claim 1, further comprising, before separating, shrinking the first portion of the glass substrate relative to the second portion of the glass substrate by preferentially cooling the first portion.

4. (canceled)

5. (canceled)

6. The method of claim 1, wherein separating comprises applying pressure during separating the first portion of the glass substrate from the second portion of the glass substrate.

7. (canceled)

8. (canceled)

9. (canceled)

10. The method of claim 1, wherein separating the first portion of the glass substrate from the second portion of the glass substrate comprises pulling the first portion of the glass substrate away from the mold.

11. (canceled)

12. The method of claim 1, wherein separating the first portion of the glass substrate from the second portion of the glass substrate comprises pulling the first portion of the glass substrate into a recess in the mold.

13. (canceled)

14. (canceled)

15. The method of claim 1, wherein the glass substrate is flat during the perforating.

16. The method of claim 1, wherein thermal forming the glass substrate comprises thermal sagging the glass substrate into the mold by heating the glass substrate to a temperature at which the glass substrate sags under its own weight.

17. The method of claim 1, further comprising:
disposing the glass substrate on a sacrificial glass substrate prior to thermal forming;
thermal forming the glass substrate and the sacrificial glass substrate into the non-planar shape with the mold;
separating the first portion of the glass substrate from the second portion of the glass substrate; and
separating the glass substrate from the sacrificial glass substrate.

18. The method of claim 1, wherein the spacing between two adjacent perforations is 1 μm to 10 μm.

19. The method of claim 1, wherein the shape of the first portion of the glass substrate is selected from the group consisting of round, oval, rectangle, and triangle.

20. The method of claim 1, wherein the glass substrate has a thickness 50 μm to 2 mm.

21. The method of claim 1, wherein the depth of the perforations is 5% to 100% of the thickness of the glass substrate.

22. The method of claim 1, wherein the laser is a pico-second laser.

23. An article, formed by a method comprising:
perforating a glass substrate along a contour with a laser forming a plurality of perforations, such that the contour separates a first portion of the glass substrate from a second portion of the glass substrate;
after perforating:
thermal forming the glass substrate into a non-planar shape with a mold; and
separating the first portion of the glass substrate from the second portion of the glass substrate.

24. A vehicle interior system comprising:
a base including a curved surface; and
the article of claim 23 disposed on the curved surface.

25. The vehicle interior system of claim 24, wherein the contour forms an opening in the glass substrate after the first portion is separated, and the curved surface comprises any one of a button, knob and vent, that is accessible through the opening.

26. The vehicle interior system of claim 1, wherein the base further comprises a display.

27. The vehicle interior system of claim 26, wherein the display is visible through the opening or through the second portion.

28. (canceled)

29. The vehicle interior system of claim 24, wherein the vehicle is any one of an automobile, a seacraft, and an aircraft.
